(19) United States
(12) Patent Application Publication
(10) Pub. No.: US 2006/0150109 A1
(43) Pub. Date: Jul. 6, 2006

(54) Shared user interface

(75) Inventors: Charles P. Schultz, North Miami Beach, FL (US); Stuart S. Kreitzer, Coral Springs, FL (US); Joseph Patino, Pembroke Pines, FL (US); Camilo E. Villamil, Pembroke Pines, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/029,107

(22) Filed: Dec. 30, 2004

(51) Int. Cl. G06F 9/00

(52) U.S. Cl. 715/759

(57) ABSTRACT

A system (200) includes a visiting wireless device (202) and a host wireless device (206) that communicate with each other. A shared user interface is commonly used by the two devices. During an ongoing interaction between a user of the visiting device (202) and a user of the host device (206), images of each user (106 and 108) are communicated to the other device and both devices display the images of both user. Through updated images communicated back and forth between the devices, the users “virtually” interact with the shared user interface. A permission level restricts the interactions available to the visiting device (202).

### FIELD OF THE INVENTION

The present invention relates generally to the field of electronic devices, and more particularly relates to using video images to interact with a user interface shared between two electronic devices.

### BACKGROUND OF THE INVENTION

Mobile communication devices are in widespread use throughout the world, and are especially popular in metropolitan regions. Initially these devices facilitated mobile telephony, but more recently these devices have begun providing many other services and functions.

Developers have been creating applications for use on mobile communication devices that allow users to perform various tasks. For example, present mobile communication devices having cameras are popular in the marketplace. These devices allow a user to take a picture or even a short video clip with the mobile communication device. The image or video can be viewed on the mobile communication device and transmitted to others. In addition, mobile communication devices are becoming more and more robust in the sense of processing abilities, with many handheld devices having the capability to run local and/or network applications. In particular, multimedia capabilities over data network services have become very popular and allow users the ability to interact with each other over networks by, for example, sending and receiving (“sharing”) pictures, drawings, sounds, video, files, programs, email and other text messages, browsing content on wide area networks like the Internet, and so on.

Recent advances in gaming technology have created devices and software that can incorporate a user's captured image into the graphic elements of a game, and recognize physical user movements in such a way as to affect graphical elements in the game.

Additionally, some recent applications allow a user of a device to access applications and data on a remote device that allows such access. However, there is currently no way for two or more users of mobile communication devices to visually coexist, cooperate, and interact with elements on each other's user interface (e.g., display).

Therefore a need exists to overcome the problems with the prior art as discussed above.

### SUMMARY OF THE INVENTION

Briefly, in accordance with the present invention, disclosed is a method for sharing a user interface. According to the method of one embodiment, at least one image of a first user of the first device is captured with a first device, and the image of the first user is sent to a second device. At least one image of a second user of the second device is received from the second device, and the image of the first user, the image of the second user, and at least one user interface element that is a graphical object representing content on the second device is simultaneously displaying in a user interface of the first device. The user interface of the first device is updated based on movement of the first user, such that the displayed image of the first user interacts with the displayed user interface element, and content represented by the displayed user interface element is received from the second device.

Also disclosed is a method for negotiating a shared user interface. In one embodiment, a first user interface identifier for a second device is received from a first device. If a current user interface of the first device corresponds to the first user interface identifier, the first user interface identifier is sent to the second device and an image of the first user, an image of the second user, and at least one user interface element that is a graphical object representing content on the second device is displayed simultaneously in the current user interface of the first device. However, if the current user interface of the first device does not correspond to the first user interface identifier but the first device is capable of displaying a second user interface that corresponds to the first user interface identifier, the first user interface identifier is sent to the second device, the current user interface of the first device is switched to that of the second user interface, and an image of the first user, an image of the second user, and at least one user interface element that is a graphical object representing content on the second device are simultaneously displayed in the second user interface on the first device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating two electronic devices sharing a user interface in accordance with an exemplary embodiment of the present invention.

FIG. 2 is a system diagram illustrating a mobile communication network in accordance with one embodiment of the present invention.

FIG. 3 is a block diagram illustrating a wireless device used in accordance with one embodiment of the present invention.

FIGS. 4 and 5 are flow diagrams of a process for sharing a user interface in accordance with one embodiment of the present invention.

FIGS. 6-9 are session flow diagrams of a process for sharing a user interface in accordance with an exemplary embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

The present invention, according to an exemplary embodiment, overcomes problems with the prior art by allowing multiple users of communication devices to appear in each other's user interfaces, and to act on each other's devices in a manner controlled by the device owner. In this embodiment, visual images are continuously transferred between the devices so that movement of one or both of the users is displayed on the devices. Therefore, each device shows the movements of a visiting user and the device owner simultaneously. In some embodiments, only a portion of an image is transmitted, such as only the person in motion. The video images are then interpreted by hardware, software, or a combination thereof, and changes in the video images are able to interact with the user interface, depending on the permission level granted to a visiting user. In this manner, elements of the user interface are manipulated through the image. Therefore, a user of a remote device can access files, play games, or access other functions remotely by making physical movements in the optical range of a camera coupled to the user's device. Additionally, the device owner can act within the same interface.

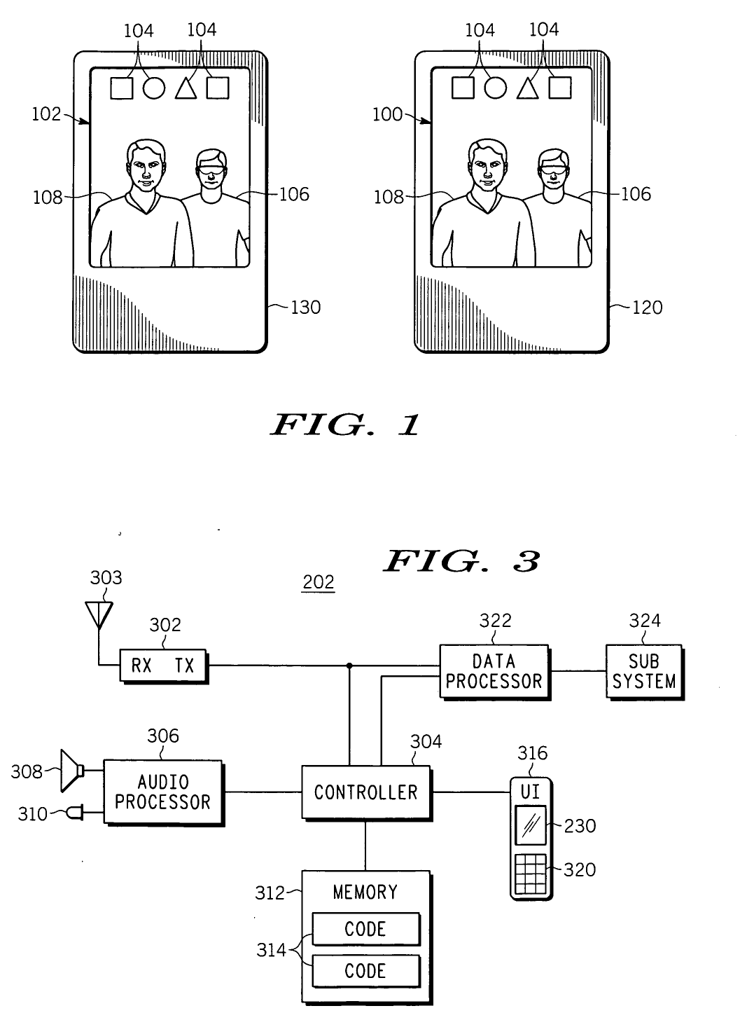

Referring now to FIG. 1, there are shown two user interfaces 100 and 102. User interface 100 is shown on the display of a first electronic device 120 and user interface 102 is shown on the display of a second electronic device 130. Each electronic device 120 and 130 can be any type of communication device that includes a camera, a communication interface, and a display, such as a cellular or wireless phone, push-to-talk mobile radio, a notebook computer, a handheld computer, a personal digital assistant (PDA), a video game device, a media player, or a desktop computer system.

The user interfaces 100 and 102 include user interface elements 104 which are graphical objects representing content on one of the devices that the users of one or both devices interact with to perform functions on the devices. The particular elements that appear and other aspects within the user interface are the result of a negotiation between the two devices to set up the shared user interface. The user interface on one device can be an exact copy of the user interface of the other device, or can include a subset of elements on the user interface of the other device, a combination of elements on both devices, or the user interface elements belonging to that device only.

Projected into both of the user interfaces 100 and 102 are images of a first user 106 of the first device 120 and a second user 108 of the second device 130. In this embodiment of the present invention, each user image is a video image captured by the camera of that user's device. Each user's image 106 and 108 is captured by the camera on their respective device and communicated to the other user's device for inclusion in the shared user interface. Thus, the images of both users and the movements of both users are represented in both of the user interfaces.

The user images 106 and 108 can interact with the graphical elements 104 in the shared user interface 100 and 102. For example, in this embodiment a user can move so as to intersect one of the elements, in order to indicate that the user wishes to interact with that particular element. In this way, various tasks, such as data manipulation, function execution, and the like, can be performed from the shared user interface. For example, the first user's hand can be raised. The camera on the first user's device captures this and communicates it so that, on both user interfaces, the graphical representation of the first user 106 intersects an element 104 of a jukebox that represents all of the songs stored on the device of the second user. Software, hardware, or both interpret the location and movement of the first user on the shared user interface and an action results. In this example, the jukebox opens to display the names of all artists stored on the device of the second user. The first user can then interact with one of these visual elements so as to display all of the songs by a particular artist. During this interaction, the image of the first user is communicated to the second device and shown on the user interface 102 of the second device, and the image of the second user is communicated to the first device and shown on the user interface 100 of the first device. Thus, each user sees a user interface showing both users, and one or both users can interact with the device of the other user, usually based on permissions.

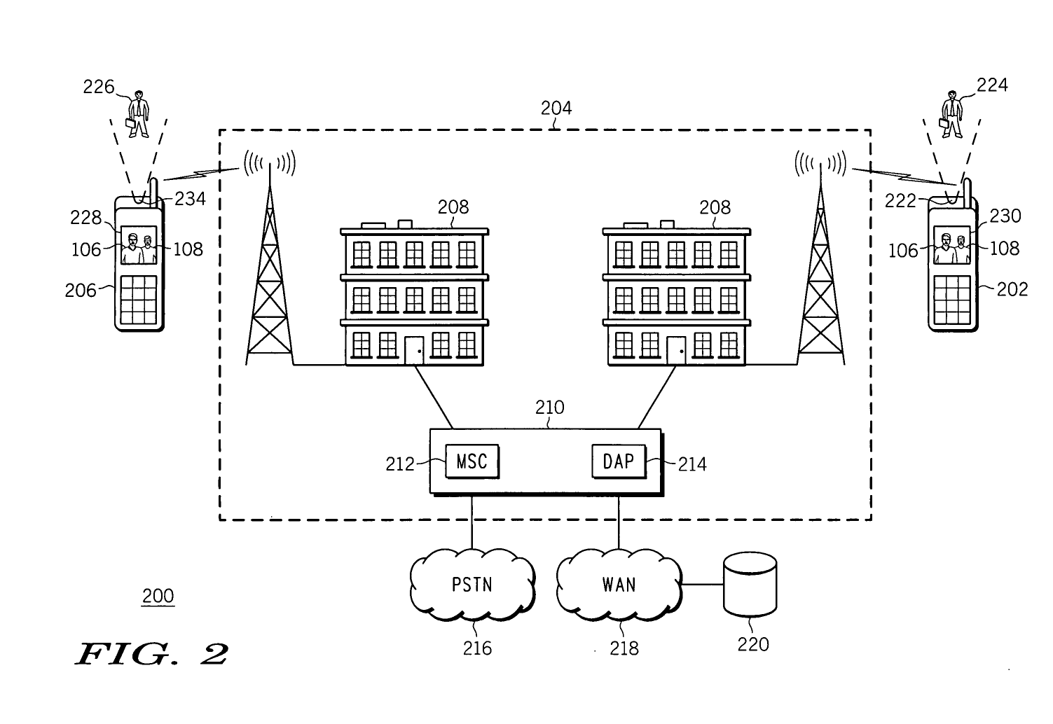

Referring now to FIG. 2, there is shown a system diagram 200 of a communication system for supporting shared user interface visual communication in accordance with one embodiment of the present invention. A first mobile communication device 202 is used by a first user 224. The first mobile communication device communicates with an exemplary communication system infrastructure 204 to link to a second mobile communication device 206. The exemplary communication system infrastructure includes base stations 208 which establish respective service areas in the vicinity of the base stations to support wireless mobile communication, as is known.

There are at least two major types of voice communication that are in widespread use, regular full duplex telephony, and half duplex “dispatch calling.” Each of these facilitates at least one of two modes, voice and non-voice. Dispatch calling includes both one-to-one “private” calling and one-to-many “group” calling. Non-voice mode communication includes SMS, chat (such as Instant Messaging), and other similar communications.

The base stations 208 communicate with a central office 210 which includes call processing equipment for facilitating communication among mobile communication devices and between mobile communication devices and parties outside the communication system infrastructure, such as mobile switching center 212 for processing mobile telephony calls, and a dispatch application processor 214 for processing dispatch or half duplex communication.

The central office 210 is further operably connected to a public telephone switching network (PTSN) 216 to connect calls between the mobile communication devices within the communication system infrastructure and telephone equipment outside the system 200. Furthermore, the central office 210 provides connectivity to a wide area data network (WAN) 218, which may include connectivity to the Internet.

The network 218 may include connectivity to a database server 220 to support querying of a user's calling parameters so that the server can facilitate automatic call setup by, for example, cross referencing calling numbers with network identifiers such as IP addresses.

Alternatively, the devices 202 and 206 can connect and communicate directly with each other in a mobile to mobile connection. In this configuration, neither the base stations nor any other network resources are utilized. In another embodiment, the devices 202 and 206 can connect directly through the Internet without utilizing any telephony infrastructure.

The communications system infrastructure 204 of this exemplary embodiment permits multiple physical communication links or channels. In turn each of these physical communication channels, such as AMPs, GSM, TDMA, CDMA, CDMA 1X, WCDMA, SMS, and so on, supports one or more communications channels such as lower bandwidth voice and higher bandwidth payload data. Further, the communications channel supports two or more formats or protocols such as voice, data, text-messaging and the like.

In this embodiment of the invention, the mobile communication device 202 includes an object image capturing device, such as a still or video camera. The object image capturing device can be built-in to the mobile communication device 202 or externally coupled to the mobile wireless device through a wired or wireless local interface. In this exemplary embodiment, a camera is the object capturing device, but any other object capturing devices can be used in further embodiments. The mobile communication device 202 includes a camera 222 for capturing an image 106 of the first user 224 and displaying the image 106 on a display 230 of the mobile communication device 202. In other embodiments, the image can be received from a network, such as the Internet, can be rendered from a software program, drawn by a user, or other similar methods. The object can also include text, temperature measurements, sounds, or anything capable of being rendered or processed on a mobile device.

The first user 224 of the first mobile communication device 202 can transmit the image 106 to the second mobile communication device 206, where the second mobile communication device 206 will provide a copy or rendered image 106 of the first user 224 on the display 228 of the second mobile communication device 206 to be viewed by the second user 226 of the second mobile communication device 206.

The second mobile communication device 206 also has a camera 234 or other image capturing device. The camera 234 is capable of capturing images of the second user 226 of the second device 206 to be displayed on the second device 206 alone or simultaneous with the images received of the user 224 of the first device 202. The images 108 of the second user 226 of the second device 206 can also be transmitted to the first device 202.

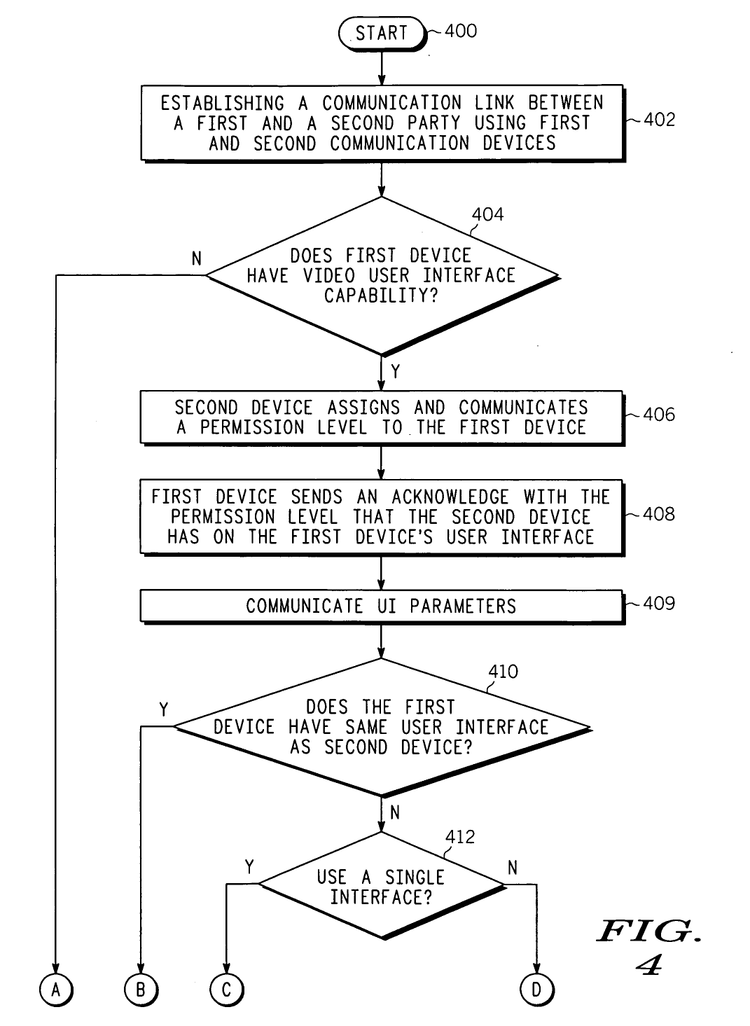

Referring now to FIG. 3, there is shown a block diagram of a mobile communication device 202 designed for use in accordance with one embodiment of the present invention. The mobile communication device 202 comprises a radio frequency transceiver 302 for communicating with the communication system infrastructure equipment 204 via radio frequency signals through an antenna 303. The operation of the mobile communication device and the transceiver is controlled by a controller 304. The mobile communication device also comprises an audio processor 306 which processes audio signals received from the transceiver to be played over a speaker 308, and it processes signals received from a microphone 310 to be delivered to the transceiver 302. The controller 304 operates according to instruction code disposed in a memory 312 of the mobile communication device. Various modules 314 of code are used for instantiating various functions, including the shared visual user interface. To allow the user to operate the mobile communication device 202 and receive information from the mobile communication device 202, the mobile communication device 202 comprises a body 316, including a display 230, and keypad 320.

Furthermore, the mobile communication device 202 comprises an additional data processor 322 for supporting a subsystem 324 attached to the mobile communication device or integrated with the mobile communication device, such as, for example, a camera 222, other image capturing device, or motion detector. The data processor 322, under control of the controller 304, operates the subsystem 324 to acquire information and graphical objects or data objects and provide it to the transceiver 302 for transmission. In some embodiments, the data processor 322 acts independently of the controller 304 (such as in one embodiment in which the data processor 322 is a graphics co-processor).

As explained above, the “user interface” is a set of graphical elements displayed on the display 230 of a device. The user interface can include lists of files, icons, sets of buttons, colors, shapes, backgrounds and the like. The user interacts with the elements defining the user interface to cause the device to perform functions, such as exchange information, execute programs, move or delete files, change visual appearances, and so on. The user interface can be circumstance dependent. For instance, if the devices are able to sense temperature, the user interface can change to cooler colors or winter-type graphics.

Embodiments of the present invention provide a shared interactive experience between two or more users whose images are projected on each other's displays 230 and 228 and who are interacting with a user interface that is shared between the first party 224 using the first communication device 202 and at least one other party 226 using the second communication device 206 in a real-time interaction.

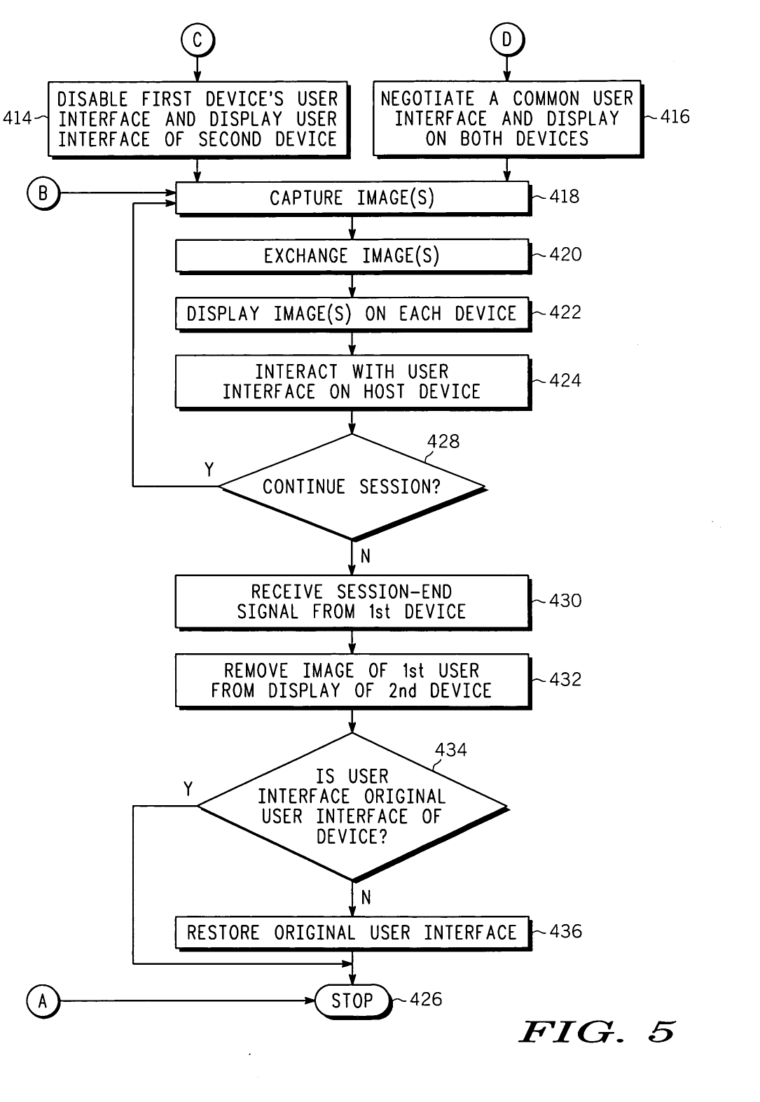

FIGS. 4 and 5 show a flow diagram of a process for sharing a user interface in accordance with one embodiment of the present invention. The process of sharing a user interface commences at step 400 and immediately moves to step 402 by establishing a communication link between a first 224 and a second party 226 using first and second communication devices 202 and 206, respectively.

The second device 206 then determines, in step 404, whether the first device 202 has video user interface capability, either by a request from the second device 206 to the first device 202 or by checking indicator bits included in the call data from the first device 202 during call setup. Video user interface capability means that the device can capture and display video images. If so, the second device, in step 406, then grants a permission level to the first device 202 either by automated means (pre-programmed setting preferences) or in response to an active request from the first device 202. If, however, the first device 202 does not have means to interact, the process moves to step 426 and the flow stops.

For purposes of illustration, the first device 202 is referred to as a visiting device and the second device 206 as a host device in this example. The visiting device interacts with the user interface of the host device. Permission levels define what rights a visiting user has on the host device. A visiting user can be limited to merely appearing on the host device without the ability to affect any user interface elements, or can be granted permission to interact with various classes or levels of applications, such as games only, or can be allowed or restricted from accessing phonebook and contact information.

It is also possible that the second device 206 will interact with the user interface of the first device 202. Therefore, upon receipt of a permission level from the second device 206, the first device 202 can send, in step 408, an acknowledgement with a permission level that the second device 206 is given to interact with the user interface on the first device. It should be noted here that it is not necessary for both devices to be granted the same operating permissions.

Typically, but not necessarily, the user of each device has full access to all resources on the device and, dependent upon the permission level granted to the visiting user, which is the user of the visiting device, the visiting user will have accesses to a subset of the host device's resources. Embodiments of the present invention recognize and track each visiting user separate from the host user. The motions associated with the visitor only affect those categories of user interface elements that are permitted by the host device. The host retains the ability to affect all relevant user interface elements.

Because the devices may not physically be the same, i.e., have the same features and abilities, the devices communicate to each other, in step 409, the user interface parameters, functions, and capabilities of each device, which define the possible interactions that can be supported on each device. The devices then determine, in step 410, whether they have a user interface style in common. If the style is the same, then no change is necessary. In such a case where the visiting device is granted the ability to affect user interface elements, but is not using a user interface style in common with the host device, the devices must decide whether they will use a single user interface from the host device or a combination of the two user interfaces, in step 412. If a single user interface is desired, the visitor device, in step 414, must disable its own interface and display that of the host device.

In one embodiment of the present invention, a user interface identifier is exchanged between connecting devices. If the identifiers match, then both devices share the same user interface. Alternatively, an identifier value of 0, or no identifier, can be sent to indicate that a device does not have a video capable user interface. Additionally, if both users are using an application that is designed to operate simultaneously for both users, such as a multiplayer game, then both devices can communicate with one another with respect to any actions from either user.

If the active user interfaces of the two communicating devices do not match, it is possible for them to negotiate or discover a common user interface, in step 416. A preference list for each device is maintained for this purpose. Upon successful negotiation, each device uses the negotiated user interface style for the duration of the call, and reverts to the original user interface at the end of the session.

In one embodiment of the present invention, as part of the user interface negotiation, one device copies or loans user interface elements to another device in order to establish a compatible session. This feature allows the “viral marketing” of user interface elements through the sharing of temporary copies with other devices.

For multiparty communications, the negotiated user interface remains in use until all parties have disconnected from each other. A new user joining a multiparty communication may initiate another negotiation process that causes user interface change for the other users. This capability can be enabled or disabled (e.g., multiparty negotiation=true/false) by the communication system 204 or the communication devices themselves. If unable to negotiate a common user interface, the new user will be unable to join the call, or may join the session without receiving any video information to incorporate.

In yet another embodiment of the present invention, if the visiting device has a different active user interface than the host device, but has the capability to use the user interface indicated by the host device's user identifier, then the visitor device switches to the host's user interface type and sends this information back to the host device, rather than engage in a more lengthy user interface type negotiation signaling transaction.

In some embodiments, the visiting user is not required to control the host device using the host device's user interface. Instead, the user interface of the host is translated and rendered to look like the visiting user's own user interface on the visiting device. For example, if the visiting user has a first brand of phone and is connecting to a second brand of phone, the visitor could still interact using the visiting phone's familiar user interface rather than having to learn the user interface of the other brand of phone. In one embodiment, the two devices employ a user-interface-independent translation layer to translate the one user interface to the other user interface for the benefit of the visiting user.

In the case where a user cannot or will not negotiate user interfaces, the user may render the other parties as video objects on his screen without using the actual video for that user and/or without using the same user interface as the host device.

In step 418, video images are captured by the cameras 222 and 234 on each device. The image can be a single still image, or a series of images that are sent serially to the other device to represent movement of the user. The images are then exchanged between the two devices in step 420. (Images can be taken and shared prior to any of the above described steps and are shown in the flow diagram following step 416 for illustrative purposes.)

In step 422, the images are displayed on the devices so that each user can see both users superimposed in the agreed upon user interface. The user interface can have elements with which the images of the users can interact, in step 424. For example, in one embodiment, a graphical representation of a jukebox is shown on the user interfaces. The jukebox represents a storage area containing all of the music files stored on the host device. The visiting device user 224, while watching the screen 230 on the first device 202, moves so as to “virtually interact” with the jukebox. The camera 222 of the visiting device 202 captures the new position of the user's hand and transmits the image 106 to the host device 206. Hardware or software, or a combination thereof, on the host device 206 interprets the new position of the visiting device user's hand and superimposes it over the jukebox. The intersection of the hand and the jukebox causes the host device to “open the jukebox” and show a list of all the songs available on the host device 206. The user 224 of the visiting device 202 can now make further movements to interact with these “song” objects, which are then captured by the camera 222 and transmitted to the host device. The effect of the further movements can be to select a particular song to be downloaded from the host device, deleted from the host device, moved to a different location, or the like, depending on the permission level granted.

Since each user is in the role of host for the device they are operating, in one embodiment of the present invention, their image is initially shown in the foreground with respect to any images of the visiting user. The display of a user in the foreground can toggle based on who is actively operating the device, either immediately upon each action, or after a period of time where one or the other remains inactive.

After the flow passes step 424 and an interaction occurs, the process continues back to step 418 if the session is to continue, at step 428. However, if a session-end signal is received, at step 430, from the first device 202, the second device 206 initiates a shutdown mode. The image of the first user 106 is then removed from the display of the second device, at step 432. Next, the user interface is checked, at step 434, to see if it is the original user interface of the second device or some other agreed upon interface. If the user interface is the original user interface, the second device may immediately proceed to step 426 where the session is ended. Conversely, if the user interface on the second device is not the original user interface, the original user interface is restored in step 436 and then the process moves to step 426 where the session is ended. If the session is not to continue, for instance, by one of the users dropping the connection or revoking permission to the other, the process stops in step 426.

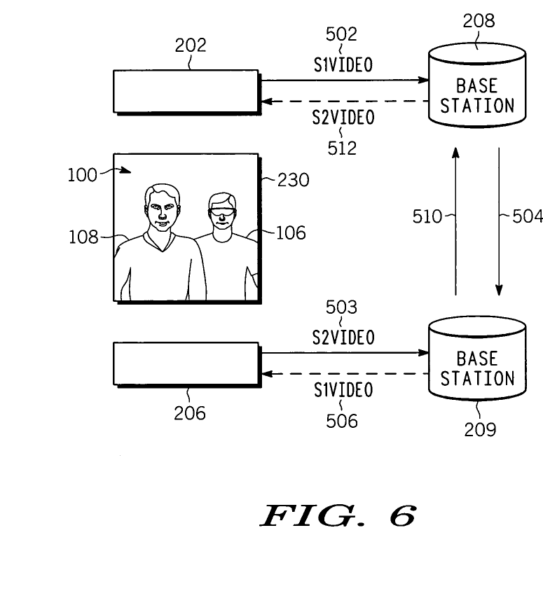

Referring now to FIG. 6, a call sequence flow diagram illustrating an exemplary embodiment of the present invention is shown. In FIG. 6, a first device 202 initiates a call to a second device 206 and the devices exchange video images of their respective users. Both user's images 106 and 108 are then shown in the same user interface 100 on both devices. In step 502, the first device 202 transfers at least one video image of the first user of the first device to a base station 208. The base station relays the information to a second base station 209, in step 504, that, in turn, relays the information to a second device 206, in step 506. Simultaneously, or subsequently, the second device 206 communicates at least one video image of the second user of the second device 206 to the second base station 209, in step 503, which then routes the image to the first base station 208, in step 510, and to the first device 202, in step 512.

Each display 228 and 230 now shows an image 106 of the first user 224 and an image 108 of the second user 226. Each user is superimposed on the negotiated shared user interface, as described above. The second user 226 (in foreground) has control of the user interface elements on the screen. The image of the first user 106 (in background) is the visiting user and can control the user interface if permitted by the second user 226, who now controls the host device 206. In this embodiment, the devices may switch roles at any time, with the first user becoming the host and the second user becoming the visitor. The second user 226 would then access the features of the first device 202.

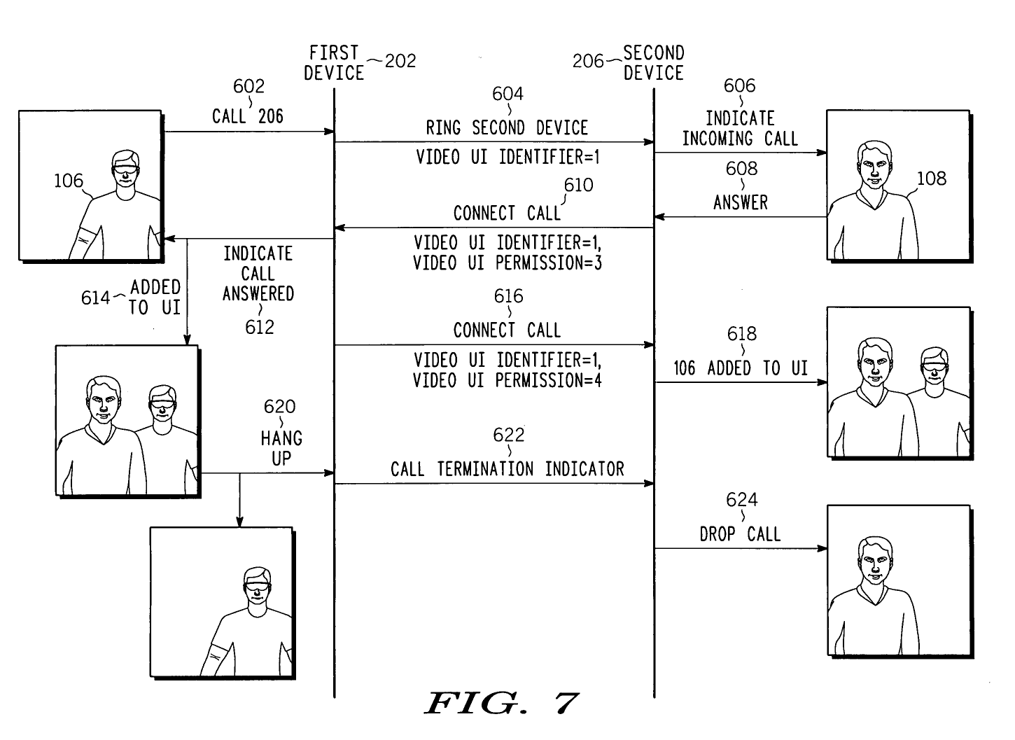

Referring now to FIG. 7, a second call sequence flow diagram describing shared video call control in this embodiment is shown. To properly negotiate a common user interface, the devices communicate specific information back and forth. Included in that information is user interface identification data, indicating what user interface each device is displaying or capable of displaying. Additionally, user interface permission data is communicated, which dictates the ability of each user to interact with elements on the other user's device. The flow in FIG. 7 illustrates the use of user interface identifiers and permission levels.

In the first step 602, the first user 106 initiates a call setup procedure to contact the second device 206. The call setup is completed in step 604 and the second device receives notification of the incoming transmission, in step 606. In the call setup, an image of the first user 106 of the first device 202 and a video user interface identifier indicating the capabilities of the first device 202 are sent to the second device 206. In the example shown, the video user identifier equals 1.

The second device 206 initiates an answer mode, in step 608, and the call is connected between the two devices, in step 610. In other embodiments, the call is a one-to-many call. When the second device 206 initiates the answer mode, the video user interface identifier of the second device is communicated to the first device 202. The user interface identifier represents one or both of: an indication of the user interface that the second device is currently using, and one or more user interfaces that the second device is willing to use (i.e., change to) in order to interoperate with the first device 202. Additionally, the second device 206, which will act as the host device, sends an image of the second user 108 and a permission level to the first device that will dictate the privileges the first user will have to interact with elements in the host device 206. In the example shown, the host device returns a video user identifier equal to 1; thus, the two devices have the same user interface and/or agree to use the same interface.

The first device 202 indicates that the call has been answered by the second device 206, in step 612, and adds the image of the second user 108 to the user interface of the first device 202, in step 614. An acknowledgement that the call has been connected is transmitted back to the second device in step 616, and the first device 202 grants a permission level to the second device 206 for interacting with elements on the first device 202. The image of the first user 106 is added to the user interface on the second device 206, in step 618.

One method of terminating the interaction is shown in FIG. 7, where the first device 202 initiates, in step 620, a hang up, and the image of the second user 108 is deleted from the display 230 of the first device 202. The hang up causes a call termination indicator to be sent, in step 622, to the second device 206. The second device 206 then drops the call, in step 624, removes the image of the first user 106, and reverts back to its previous user interface. In some embodiments, a hang timer is used to identify and reconnect dropped sessions or calls. For example, the session can be dropped and reconnected when a predetermined amount of time passes without receiving an updated image from the second device.

After the initial call setup and exchange of images occurs, the images are updated to represent movement by the users. In this embodiment, new images are continuously transferred back and forth between the devices to allow fluid video of both users to be displayed on both devices. In other embodiments, the images are exchanged as single new images. In some such embodiments, images are only updated when motion beyond a certain threshold is detected.

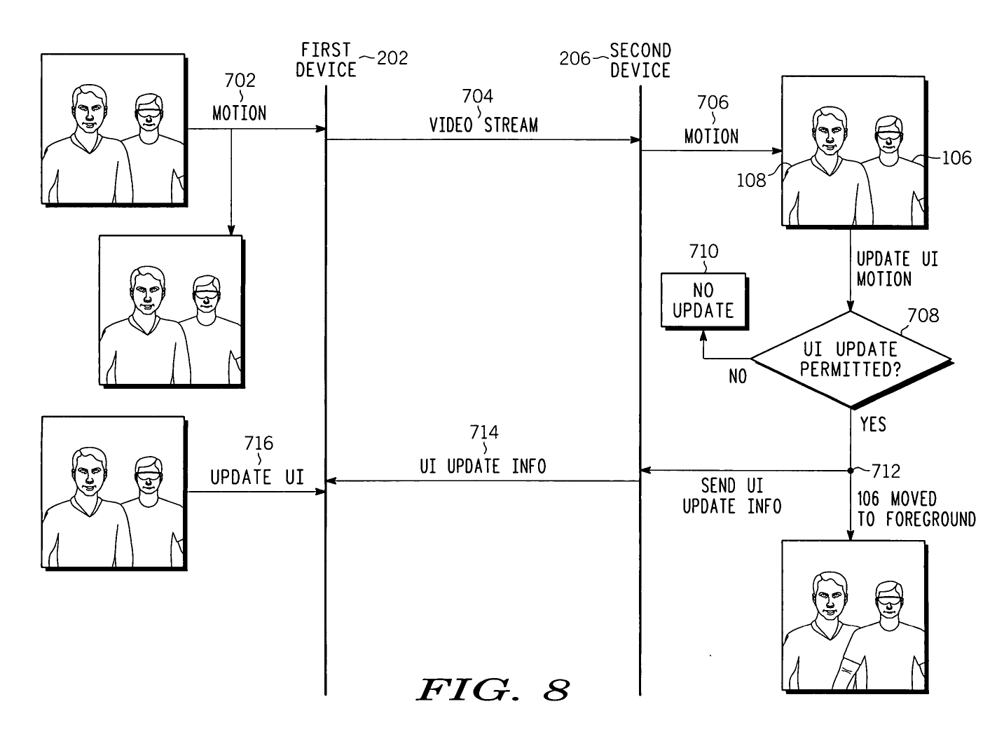

Referring now to FIG. 8, a call sequence flow diagram describing image updating in this embodiment is shown. The devices have completed a call setup procedure prior to process shown in FIG. 8. In step 702, motion is detected by the first device 202. The motion can be detected with a dedicated motion detector, with a camera 222 and software, or in another known manner. An image of the new position of the user is taken with the camera 222, and the new image is transferred, in step 704, to the second device 206. In step 706, the second device 206 interprets this communication. In step 708, the second device 206 interprets the motion as intending to access or manipulate one of the user interface elements (e.g., move or open), and checks the permission level granted to the first device 202 to determine if such access or manipulation is allowed. If not allowed, in step 710, then the element is not affected. The first device can notify its user audibly, physically (e.g., by vibrating), and/or visually of the unsuccessful attempt based on either an explicit message from the second device 206 or the lack of a positive response or change to the target user interface within a predetermined amount of time. However, if the permission level previously or currently assigned to the second device does allow updating, in step 712, the image of the first user 106 is moved to the foreground of the screen 230, the image is replaced with the updated version, and user interface update information is output from the second device 206. In step 714, the user interface update information is transferred to the first device 202 and, in step 716, the display on the first device is updated. In some embodiments, the display is updated only when motion beyond a certain threshold is detected.

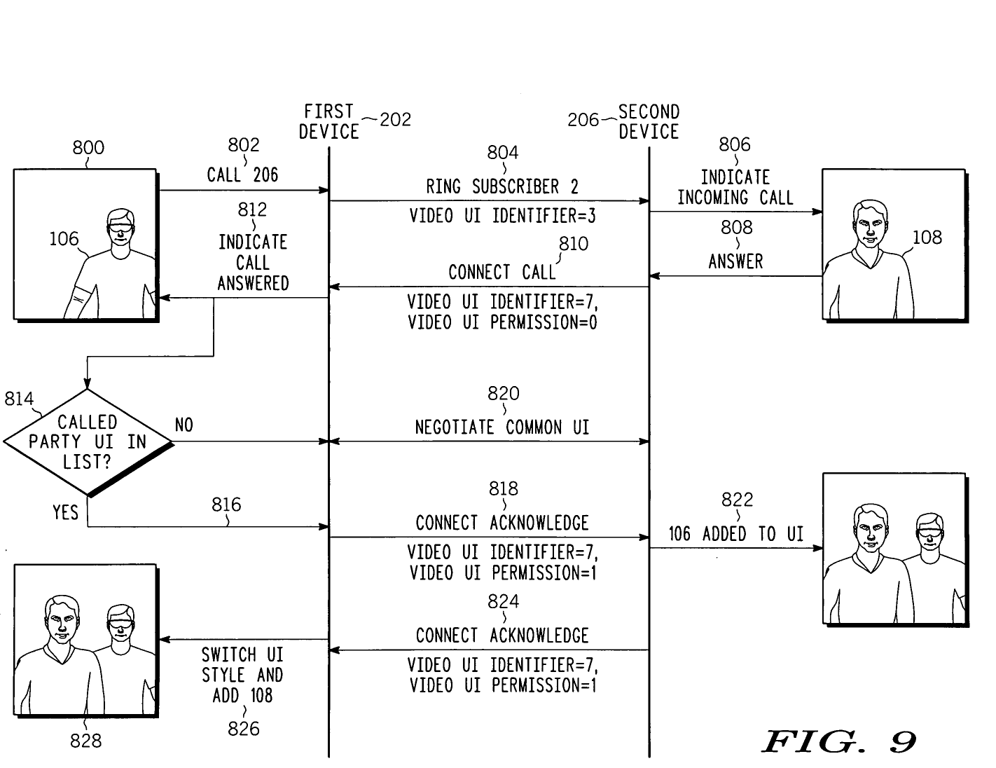

Referring now to FIG. 9, a call sequence flow diagram for devices not using the same user interface in this embodiment is shown. In FIG. 9, negotiation takes place between the two devices 202 and 206 and a common user interface that can be displayed on both devices results. In step 802, as in the process FIG. 7, the first user 106 initiates a call setup procedure to contact the second device 206. The call setup is completed in step 804 and the second device 206 receives notification of the incoming transmission, in step 806. In the call setup, an image of the user 106 of the first device 202 and a video user interface identifier indicating the capabilities of the first device 202 are sent to the second device 206. In this example, the video user interface identifier is 3. The second device 206 initiates an answer mode, in step 808, and the call is connected, in step 810. When the second device 206 initiates the answer mode, the video user interface identifier of the second device 206 is communicated to the first device 202. In the example shown in FIG. 9, the video user interface identifier of the second device 206 is 7, which differs from that of the first device 202. Additionally, the second device 206, which will act as the host device in this example, sends a permission level identifier to the first device. The permission level identifier dictates the privileges the first user will have to interact with elements of the host device 206. The second device 206 also sends an image of the second user 108 to the first device 202.

At the first device 202, the difference in the video user interface identifiers is recognized in step 812. The device then negotiates a common interface. In step 814, the first device searches a memory to determine if the user interface of the host device 206 is available on the first device 202. If the video user interface identifier is recognized and available, in step 816, the first device communicates an acknowledge signal to the second device, confirming the user interface to be used, along with a permission level granted to the second device 206, in step 818. If the video user interface identifier is not recognized or available, the devices must negotiate a different common user interface, in step 820, through one or more communications of other interface identifiers until a commonly available interface is found.

An image of the first user 106 is then added to the user interface of the second device 206, along with the image of the second user 108, in step 822. Both users now appear simultaneously, sharing control of the user interface as described above. An acknowledgement of the connection is sent to the first device 202 in step 824. In step 826, the first device 202 switches from its original user interface 800 to the user interface 828 defined in the video user interface identifier negotiated with the second device 206 in step 810.

Embodiments of the present invention provide many advantages. For example, real-time interaction is allowed between a remote user and a device under the control of another user. Two or more users can interact with each other and with elements in a commonly agreed upon user interface. Additionally, the users of each device need not physically interact with their respective devices to cause the interactions to occur. A camera or other device captures movements at a distance away from the device. A user need only gesture to cause the intended action to be carried out on one or both devices.

It is important to realize that many other embodiments are possible without departing from the true spirit and scope of the invention. For instance, as opposed to the alternating user control described above, the users can work simultaneously within the shared user interface to accomplish a common task or different tasks, or can work against each other in game-type environments, for instance. In addition, the shared user interface can change and develop over time. The user interface does not need to be negotiated as a whole, but can be negotiated in parts. For example, two users may retain their own personalized background screen images while sharing foreground user interface elements such as icons and menu bars. In such embodiments, each user interface element is negotiated using different value fields or bits in the user interface indication message. Permissions can also be granted separately to such categories of elements.

It is also envisioned that a user will have the ability to bring “items” into the interface with him. The items can include, for instance, date books, music, ring tones, files, graphic images, and others. The user may share them with the other user, or utilize them while in the user interface of the host device. In one embodiment, the items are associated with the “owning” user as icons “stuck” to the owner's body. In other embodiments, protected items appear, or may show up, with an element such as a padlock to indicate their protected status. Sharing users can have a virtual “bag,” which can be opened up and inspected by the other user, who can select items for transfer or use. One such item could be a CD case that another user could open up and select files to receive from the owner or to be played.

Furthermore, the two devices do not have to be physically similar to one another. For instance, one device can be a mobile telephone that communicates and interact with a desktop computer via the Internet or satellite communication. Other devices can include PDAs, laptops, game consoles, and so on, both wired and wireless.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for sharing a user interface, the method comprising the steps of:
capturing with a first device at least one image of a first user of the first device;
sending the image of the first user to a second device;
receiving from the second device at least one image of a second user of the second device;
simultaneously displaying in a user interface of the first device the image of the first user, the image of the second user, and at least one user interface element that is a graphical object representing content on the second device;
updating the user interface of the first device, based on movement of the first user, such that the displayed image of the first user interacts with the displayed user interface element; and
receiving from the second device content represented by the displayed user interface element.

2. The method according to claim 1, wherein the updating step includes the sub-steps of:
capturing with the first device a second image of the first user; and
sending the second image to the second device.

3. The method according to claim 1, further comprising the step of receiving from the second device a permission level for interacting with the second device.

4. The method according to claim 1, wherein in the capturing step, the image of the first user is captured by a camera of the first device.

5. The method according to claim 1, further comprising the step of receiving from the second device one or more user interface identifiers for the second device.

6. The method according to claim 5, further comprising the step of sending to the second device a user interface identifier for the first device.

7. A method for sharing a user interface, the method comprising the steps of:
capturing with a first device at least one image of a first user of the first device;
sending the image of the first user to a second device;
receiving from the second device at least one image of a second user of the second device;
simultaneously displaying in a user interface of the first device the image of the first user, the image of the second user, and at least one user interface element that is a graphical object representing content on the first device;
receiving from the second device an updated image of the second user of the second device, the updated image representing movement of the second user such that the displayed image of the second user interacts with the displayed user interface element; and
sending to the first device content represented by the displayed user interface element.

8. The method according to claim 7, further comprising the step of sending to the second device a permission level for interacting with the first device.

9. The method according to claim 7, wherein in the capturing step, the image of the first user is captured by a camera of the first device.

10. The method according to claim 7, further comprising the step of sending to the second device one or more user interface identifiers for the first device.

11. The method according to claim 10, further comprising the step of receiving from the second device a user interface identifier for the second device.

12. The method according to claim 7, wherein in the displaying step, the image of the second user is displayed in the foreground with respect to the image of the first user to order indicate that the second user has control.

13. The method according to claim 7, further comprising the step of terminating the session and reconnecting if a predetermined time passes without receiving an updated image from the second device.

14. A method for negotiating a shared user interface, the method comprising the steps of:
receiving from a first device a first user interface identifier for a second device;
if a current user interface of the first device corresponds to the first user interface identifier, performing the sub-steps of:
sending to the second device the first user interface identifier; and
simultaneously displaying in the current user interface of the first device an image of the first user, an image of the second user, and at least one user interface element that is a graphical object representing content on the second device; and
if the current user interface of the first device does not correspond to the first user interface identifier but the first device is capable of displaying a second user interface that corresponds to the first user interface identifier, performing the sub-steps of:
sending to the second device the first user interface identifier;
switching the current user interface of the first device to the second user interface; and
simultaneously displaying in the second user interface on the first device an image of the first user, an image of the second user, and at least one user interface element that is a graphical object representing content on the second device.

15. The method according to claim 14, further comprising the step of:
if the current user interface of the first device does not correspond to the first user interface identifier and the first device is not capable of displaying a second user interface that corresponds to the first user interface identifier, negotiating a common user interface to be displayed on both devices.

16. The method according to claim 15, wherein the negotiating step includes the sub-step of repeating sending to and receiving from the second device other user interface identifiers until the sent user interface identifier and the received user interface identifier match.

17. The method according to claim 15, further including the steps of:
capturing with the first device at least one image of the first user of the first device;
sending the image of the first user to the second device; and
receiving from the second device at least one image of the second user of the second device.

18. The method according to claim 15, further comprising the step of receiving from the second device a permission level for interacting with the second device.

19. A wireless device that is capable of using a shared user interface, the wireless device comprising:
an object capturing device for capturing at least one image of a first user of the wireless device;
a transmitter for sending the image of the first user to a second device;
a receiver for receiving from the second device at least one image of a second user of the second device;
a display simultaneously displaying in a user interface of the wireless device the image of the first user, the image of the second user, and at least one user interface element that is a graphical object representing content on the second device;
a controller for updating the user interface of the wireless device, based on movement of the first user, such that the displayed image of the first user interacts with the displayed user interface element; and
wherein the receiver further receives from the second device content represented by the displayed user interface element.

20. The wireless device according to claim 19, wherein the receiver further receives from the second device a permission level for interacting with the second device.
